(19) United States
(12) Patent Application Publication
(10) Pub. No.: US 2017/0216796 A1
(43) Pub. Date: Aug. 3, 2017

(54) FLUID MIXING DEVICE

(71) Applicant: ALPS ELECTRIC CO., LTD., Tokyo (JP)

(72) Inventor: Kenichiro SAMESHIMA, Tokyo (JP)

(21) Appl. No.: 15/486,359

(22) Filed: Apr. 13, 2017

Related U.S. Application Data
(63) Continuation of application No. PCT/JP2015/073482, filed on Aug. 21, 2015.

(30) Foreign Application Priority Data
Oct. 14, 2014 (JP) 2014-210246

(51) Int. Cl. B01F 13/00; B01L 3/00; B01F 5/06

(52) U.S. Cl. CPC B01F 13/0061; B01F 5/0603; B01L 3/502; B01F 2215/0037; B01F 2215/0034; B01L 2300/0887; B01L 2200/16; B01L 2300/0867; B01L 2300/0864

(57) ABSTRACT

A fluid mixing device is provided with a plurality of flow channel units disposed to be divided in a plurality of layers. Each of the flow channel units has an inflow port, an outflow port, and a plurality of branch flow channels making the inflow port and the outflow port communicate with each other. The flow channel units located in different layers are connected to each other at the inflow port and the outflow port between the flow channel units, thereby configuring a three-dimensional flow channel as a whole. When the direction from the inflow port to the outflow path of each flow channel unit is set to be a flow direction in the flow channel unit, the flow directions intersect each other between the respective layers.

### CLAIM OF PRIORITY

This application is a Continuation of International Application No. PCT/JP2015/073482 filed on Aug. 21, 2015, which claims benefit of Japanese Patent Application No. 2014-210246 filed on Oct. 14, 2014. The entire contents of each application noted above are hereby incorporated by reference.

### BACKGROUND OF THE DISCLOSURE

1. Field of the Disclosure

The present disclosure relates to a fluid mixing device that mixes a plurality of inflow fluids and makes the mixed fluid flow out.

2. Description of the Related Art

As a fluid mixing device, a micro-mixer or a micro-reactor that mixes a sample of human body ingesta or the like with a reagent to chemically react or analyze the sample can be given. In a fluid mixing device disclosed in Japanese Unexamined Patent Application Publication No. 2008-284626, a flow channel is formed by providing a groove in a flow channel plate. The flow channel is provided with two inflow paths for respectively introducing a sample and a reagent and one outflow path and is made such that the sample and the reagent introduced into the two inflow paths join together and are led to the outflow path.

The flow channel of the fluid mixing device disclosed in Japanese Unexamined Patent Application Publication No. 2008-284626 is planar, and the sample and the reagent join together from the two inflow paths and flow in one direction to the outflow path. In such a planar flow channel, there is a problem in which mixing efficiency is poor, even though fluids join together. Further, in order to increase the mixing efficiency, it is also conceivable to lengthen a flow channel for making fluids join together or to increase the number of branches and joins. However, in such a flow channel configuration, the installation area increases.

### SUMMARY OF THE DISCLOSURE

The present disclosure provides a fluid mixing device in which it is possible to efficiently enhance the mixing rate of fluids without excessively increasing the installation area.

According to an aspect of the present invention, there is provided a fluid mixing device that mixes a plurality of fluids, including: a plurality of flow channel units disposed to be divided in a plurality of layers, in which each of the flow channel units has only one inflow port, only one outflow port, and a plurality of branch flow channels making the inflow port and the outflow port communicate with each other, the inflow port of the flow channel unit on one side, out of the flow channel units which are located in different layers, and the outflow port of the flow channel unit on the other side are connected to each other, whereby a three-dimensional flow channel is configured such that a length of a flow channel through which the fluid flows is the same or substantially the same in any of the branch flow channels, and when a direction from the inflow port to the outflow port is set to be a flow direction of the fluid in each of the flow channel units, the flow directions intersect each other between the respective layers.

In the fluid mixing device according to the aspect of the present invention, if a plurality of fluids are introduced, diverging, joining, and a change in direction are repeated through the respective flow channel units of the three-dimensional flow channel, and therefore, it is possible to efficiently mix the fluids and make the mixed fluid flow out. At this time, the flow directions in the flow channel units intersect each other between the respective layers, and therefore, every time the fluid flows through the flow channel unit of each layer, the fluid can be divided in different directions and the divided fluids can be joined together, and the division and the joining can be repeated with a direction changed. In this way, it is possible to greatly improve the mixing efficiency of a plurality of fluids. Further, the flow channel unit is disposed in each layer, and therefore, the number of flow channel units can be increased by increasing the number of layers. In this way, it is possible to efficiently increase the mixing efficiency of a plurality of fluids without changing the installation area.

In the fluid mixing device according to the aspect of the present invention, it is preferable that the flow directions in the connected flow channel units are orthogonal to each other.

The flow directions in the flow channel units disposed in different layers are made to be orthogonal to each other, whereby it is possible to make the fluid be branched in an orthogonal direction when the fluid flows from one flow channel unit to the next flow channel unit, and thus it is possible to increase the mixing efficiency of the fluid.

In the fluid mixing device according to the aspect of the present invention, the branch flow channels of the flow channel unit may be configured with two first flow channels which divide the fluid flowing in from the inflow port into two fluid flows and lead the split fluids in directions in which the split fluids become more distant from each other, and two second flow channels which turn the split fluids from the respective first flow channels so as to lead the split fluids in directions in which the split fluids approach each other, and make the split fluids join together.

In this case, it is preferable that an angle between the two first flow channels is an angle greater than 90 degrees and less than or equal to 180 degrees and an angle between the two second flow channels is an angle smaller than 180 degrees. Further, it is preferable that the first flow channels and the second flow channels are straight lines or curved lines.

According to the present invention, it is preferable that a plurality of the flow channel units are disposed in at least one of the layers.

Further, it is further preferable that at least two of the layers having the plurality of flow channel units are stacked.

The fluid mixing device according to the aspect of the present invention can have a configuration in which a plurality of flow channel plates are laminated to be stacked in a thickness direction thereof, the flow channel unit is formed between a groove formed in a surface of the flow channel plate on one side and a flat surface of the flow channel plate on the other side which is stacked on the flow channel plate on one side, and three or more of the flow channel plates are stacked, whereby the plurality of layers are formed.

According to the fluid mixing device according to the aspect of the present invention, the flow directions in the flow channel units intersect each other between the respective layers, and therefore, every time the fluid flows through the flow channel unit of each layer, the fluid can be divided, and furthermore, such division and convergence of the fluid can be repeated while changing a direction. Accordingly, it is possible to greatly improve the mixing efficiency of a plurality of fluids. Further, the number of flow channel units can be increased by increasing the number of layers, and therefore, it is possible to increase the mixing efficiency of the fluid without widening the plane area.

### BRIEF DESCRIPTION OF THE DRAWINGS

FIG. 1 is a perspective view showing the external appearance of a fluid mixing device according to an embodiment of the present invention;

FIG. 2 is a perspective view for describing the configuration of a three-dimensional flow channel which is formed inside of the fluid mixing device according to the embodiment;

FIG. 3 is a perspective view for describing the basic shape of a flow channel unit configuring the three-dimensional flow channel shown in FIG. 2;

FIG. 4 is a plan view of the basic shape of the flow channel unit shown in FIG. 3;

FIG. 5 is a perspective view for describing a flow channel pattern which is included in the three-dimensional flow channel shown in FIG. 2;

FIG. 6 is a perspective view for describing a flow of a fluid flowing through the three-dimensional flow channel in the embodiment;

FIG. 7 is an exploded perspective view for describing the configuration of the fluid mixing device shown in FIG. 1;

FIG. 8 is a perspective view showing the configuration of a flow channel plate configuring a second layer shown in FIG. 7;

FIG. 9 is a bottom view of the flow channel plate shown in FIG. 8;

FIG. 10 is a diagram showing a modification example of the basic shape of the flow channel unit in the embodiment; and

FIG. 11 is a diagram showing another modification example of the basic shape of the flow channel unit in the embodiment.

### DETAILED DESCRIPTION OF THE DISCLOSURE

Hereinafter, a fluid mixing device according to an embodiment of the present invention will be described in detail with reference to the accompanying drawings. Here, a fluid mixing device that mixes a reagent with a human body ingesta sample such as blood is taken as an example. However, fluids to be mixed are not limited thereto.

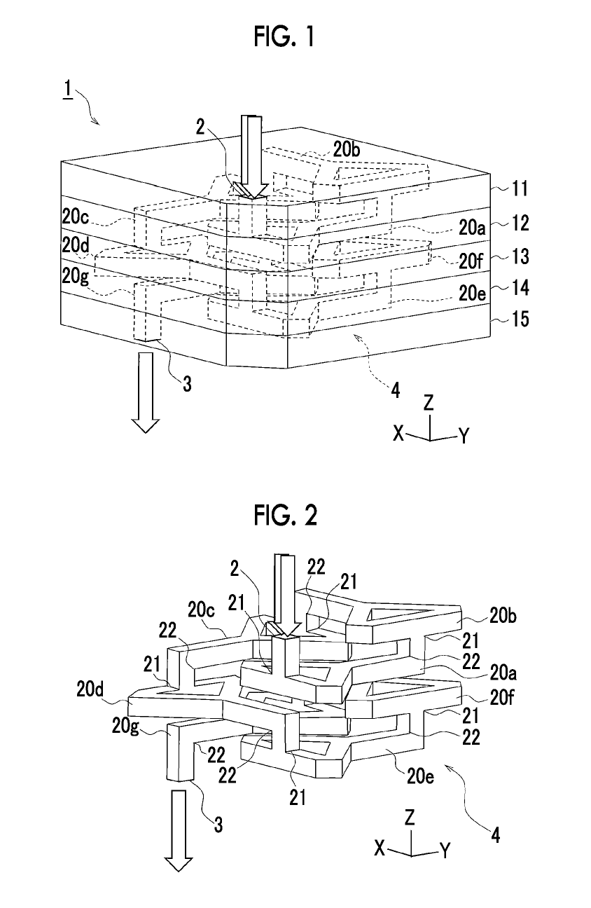

FIG. 1 is an external perspective view showing the overall configuration of a fluid mixing device 1 according to an embodiment of the present invention, and FIG. 2 is a diagram showing the shape of a three-dimensional flow channel which is formed inside of the fluid mixing device 1.

The fluid mixing device 1 shown in FIG. 1 is provided with a fluid inlet 2 provided at the uppermost part thereof and a fluid outlet 3 provided at the lowermost part. The fluid inlet 2 and the fluid outlet 3 communicate with a three-dimensional flow channel 4 formed inside of the fluid mixing device 1. If a plurality of fluids are introduced from the fluid inlet 2, the fluids are mixed in the three-dimensional flow channel 4 and the mixed fluid is discharged from the fluid outlet 3.

As shown in FIG. 2, the three-dimensional flow channel 4 is configured of a plurality of flow channel units 20 disposed in a plurality of layers arranged in an up-and-down direction. The flow channel units 20 are configured in the same basic shape and disposed to be divided in a plurality of layers. In the three-dimensional flow channel 4 shown in FIG. 2, seven flow channel units 20 are disposed to be divided in four layers. In FIG. 2 and the subsequent drawings, in order to distinguish the individual flow channel units 20 from each other, there is a case where the individual flow channel units are described to be denoted by reference numerals 20a to 20g. If a fluid is introduced from the fluid inlet 2, the fluid flows through the flow channel unit 20a, the flow channel unit 20b, the flow channel unit 20c, the flow channel unit 20d, the flow channel unit 20e, the flow channel unit 20f, and the flow channel unit 20g in this order and is discharged from the fluid outlet 3.

If the layers of the three-dimensional flow channel 4 shown in FIG. 2 are set to be first to fourth layers from the top, one flow channel unit 20b is disposed in the first layer, and two flow channel units 20a and 20c are disposed in the second layer. Two flow channel units 20f and 20d are disposed in the third layer, and two flow channel units 20e and 20g are disposed in the fourth layer.

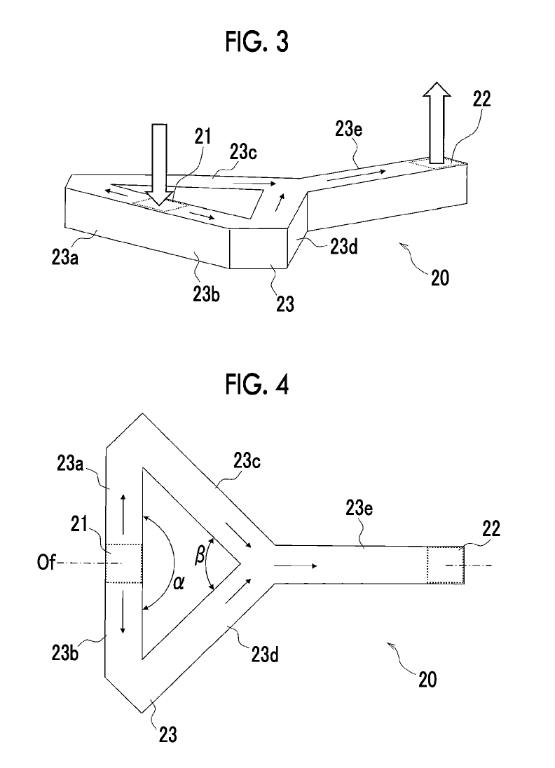

Here, the basic shape of each of the flow channel units 20a to 20g will be described with reference to the drawings. FIG. 3 is a perspective view showing the basic shape of the flow channel unit 20 in this embodiment, and FIG. 4 is a plan view of the basic shape of the flow channel unit shown in FIG. 3.

As shown in FIGS. 3 and 4, each of the flow channel units 20 is provided with an inflow port 21 and an outflow port 22 and configured such that the fluid flowing in from the inflow port 21 forms a flow in one direction (here, a horizontal direction) toward the outflow port 22. Two branch flow channels 23 making the inflow port 21 and the outflow port 22 communicate with each other are formed on the way from the inflow port 21 to the outflow port 22.

The branch flow channels 23 are configured with two first flow channels 23a and 23b which divide the fluid flowing in from the inflow port 21 into two fluid flows and lead the split fluids in directions in which the split fluids become more distant from each other, and two second flow channels 23c and 23d which turn the split fluids from the respective first flow channels 23a and 23b so as to lead the split fluids in directions in which the split fluids approach each other, and make the split fluids join together. An angle α between the first flow channels 23a and 23b is greater than 90 degrees and less than or equal to 180 degrees, and an angle β between the second flow channels 23c and 23d is smaller than 180 degrees. In this way, the split flows can turn and join together. In the embodiment shown in FIG. 4, the angle α between the first flow channels 23a and 23b is 180 degrees and the angle β between the second flow channels 23c and 23d is 90 degrees. In order to efficiently divide the fluid flowing in from the inflow port 21, it is preferable that the angle α between the first flow channels 23a and 23b is 180 degrees.

In the flow channel unit 20 shown in FIG. 3, a joining flow channel 23e for further leading the fluid joined through the second flow channels 23c and 23d to the outflow port 22 is continuously formed.

In the three-dimensional flow channel 4 shown in FIG. 2, the flow channel units 20 located in different layers are connected to each other. For example, the outflow port 22 of the flow channel unit 20a is connected to the inflow port 21 of the flow channel unit 20b located in the layer above the flow channel unit 20a, and the outflow port 22 of the flow channel unit 20b is connected to the inflow port 21 of the flow channel unit 20c located in the layer below the flow channel unit 20b.

For this reason, in each flow channel unit 20, the directions of openings of the inflow port 21 and the outflow port 22, that is, directions in which the fluids flow through the inflow port 21 and the outflow port 22 are perpendicular to the flow direction of the fluid in the flow channel unit 20 (the plane of FIG. 3).

The inflow port 21 and the outflow port 22 are open toward either of the upper side or the lower side according to the layer to which the flow channel unit is connected. For example, in the flow channel unit 20a shown in FIG. 2, both the opening direction of the inflow port 21 and the opening direction of the outflow port 22 are upward. However, in the flow channel unit 20d, the opening direction of the inflow port 21 is upward and the opening direction of the outflow port 22 is downward. In the flow channel unit 20 shown in FIG. 3, both the opening directions of the inflow port 21 and the outflow port 22 are upward, and thus both of the flow channel unit which is connected to the inflow side of the flow channel unit 20 and the flow channel unit which is connected to the outflow side of the flow channel unit 20 are located in the layer above the flow channel unit 20.

In this manner, the flow channel units 20 located in different layers are connected to each other at the inflow port 21 and the outflow port 22, thereby configuring the three-dimensional flow channel 4 as a whole. That is, the inflow port 21 of the flow channel unit 20 is connected to the outflow port 22 of the flow channel unit of the layer different from the layer in which the flow channel unit 20 is disposed, and the outflow port 22 of the flow channel unit 20 is connected to the inflow port 21 of the flow channel unit of the layer further different from the layer in which the flow channel unit 20 is disposed. In this manner, by connecting the flow channel units of the respective layers, it is possible to configure various flow channel patterns.

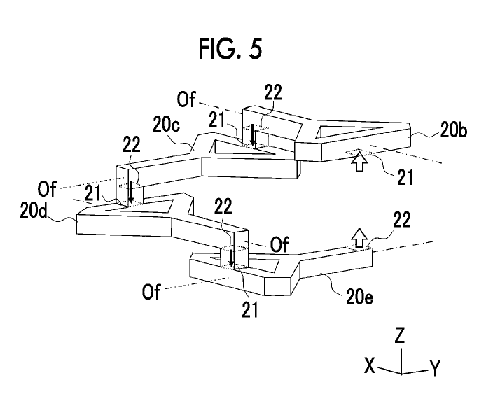

In FIG. 5, a part, that is, the flow channel units 20b to 20e of the three-dimensional flow channel 4 shown in FIG. 2 are taken out and shown.

In the flow channel pattern shown in FIG. 5, the flow directions of the fluids in the respective flow channel units 20b to 20e intersect each other at an angle of 90 degrees. In this specification, as shown in FIG. 4, in each flow channel unit 20, the direction of a center line Of which connects the center of the inflow port 21 and the center of the outflow port 22 and is parallel to the plane of FIG. 4 is set to be the flow direction of the fluid. In the flow channel pattern shown in FIG. 5, all the flow directions of the fluids in the respective flow channel units 20b to 20e connected to each other are orthogonal to each other. That is, the center lines Of of the flow channel units 20 connected to each other are orthogonal to each other. The flow direction (the direction of the center line Of) in the flow channel unit 20b is an X direction in an X-Y-Z orthogonal coordinate, and the flow direction in the flow channel unit 20c is a Y direction. The flow direction in the flow channel unit 20d is the X direction and is a direction opposite to the flow direction in the flow channel unit 20b. The flow direction in the flow channel unit 20e is the Y direction and is a direction opposite to the flow direction in the flow channel unit 20c.

With such a configuration, every time the fluid flows through the flow channel unit of each layer, the fluid can flow with the flow direction thereof being divided vertically, and the flow of the fluid can be repeated while changing a direction. In this way, it is possible to greatly improve the mixing efficiency of a plurality of fluids. Further, as shown in FIG. 5, it is possible to form a flow that makes one revolution in the fluid mixing device 1, and therefore, it is possible to reduce the installation area of the entire flow channel.

In the three-dimensional flow channel 4 shown in FIG. 2, the inflow port 21 of the flow channel unit 20b located in the first layer is directed downward and is connected to the outflow port 22 of the flow channel unit 20a located in the second layer. The outflow port 22 of the flow channel unit 20b is directed downward and is connected to the inflow port 21 of the flow channel unit 20c of the second layer. The outflow port 22 of the flow channel unit 20c of the second layer is directed downward and is connected to the inflow port 21 of the flow channel unit 20d of the third layer. The outflow port 22 of the flow channel unit 20d is directed downward and is connected to the inflow port 21 of the flow channel unit 20e of the fourth layer. The outflow port 22 of the flow channel unit 20e is directed upward and is connected to the inflow port 21 of the flow channel unit 20f located in the third layer. Then, the outflow port 22 of the flow channel unit 20f is connected to the inflow port 21 of the flow channel unit 20g located in the fourth layer.

In all the flow channel units 20a to 20g, the flow directions (the directions of the center lines Of) in the connected flow channel units are orthogonal to each other.

Further, the fluid inlet 2 communicates with the inflow port 21 of the flow channel unit 20a, and the fluid outlet 3 communicates with the outflow port 22 of the flow channel unit 20g.

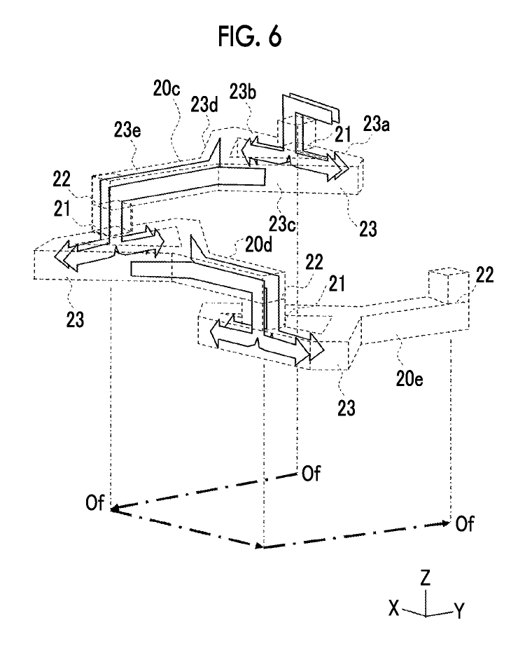

FIG. 6 is for describing the flow of the fluid when it passes through the flow channel units 20c, 20d, and 20e shown in FIG. 5. As shown in FIG. 6, if the fluid changes a direction and flows into the inflow port 21 of the flow channel unit 20c from the Z direction, the fluid is divided into two fluid flows by the branch flow channels 23 (the first flow channels 23a and 23b) of the flow channel unit 20c, thereby flowing in the directions opposite to each other in the X direction, and thereafter, the split fluids turn so as to pass through the second flow channels 23c and 23d and join together in the Y direction, and the joined fluid is led to the outflow port 22. The fluid changes the flow direction by 90 degrees, flows into the inflow port 21 of the flow channel unit 20d from the Z direction, and is divided into two fluid flows by the branch flow channels 23 of the flow channel unit 20d, thereby flowing in the directions opposite to each other in the Y direction, and thereafter, the split fluids turn and join together in the X direction, and the joined fluid is led to the outflow port 22. The fluid changes the flow direction by 90 degrees, flows into the inflow port 21 of the flow channel unit 20e from the Z direction, and is divided into two fluid flows by the branch flow channels 23 of the flow channel unit 20e, thereby flowing in the directions opposite to each other in the X direction, and thereafter, the split fluids turn and join together in the Y direction, and the joined fluid is led to the outflow port 22.

In this manner, the direction (the X direction) in which the flow of the inflow fluid is divided in the flow channel unit 20c, the direction (the Y direction) in which the flow of the inflow fluid is divided in the next flow channel unit 20d, and the direction (the X direction) in which the flow of the inflow fluid is divided in the next flow channel unit 20e are always directions intersecting each other, preferably, directions orthogonal to each other, and therefore, it is possible to greatly improve the mixing efficiency of the fluid.

Next, the laminated structure of the three-dimensional flow channel 4 will be described in detail. The three-dimensional flow channel 4 as shown in FIG. 2 may be configured by making each of the flow channel units 20a to 20g with a pipe and connecting them. However, as in the embodiment, it is preferable that the respective layers are configured with a plurality of flow channel plates and the flow channel unit is configured of a groove formed in each flow channel plate.

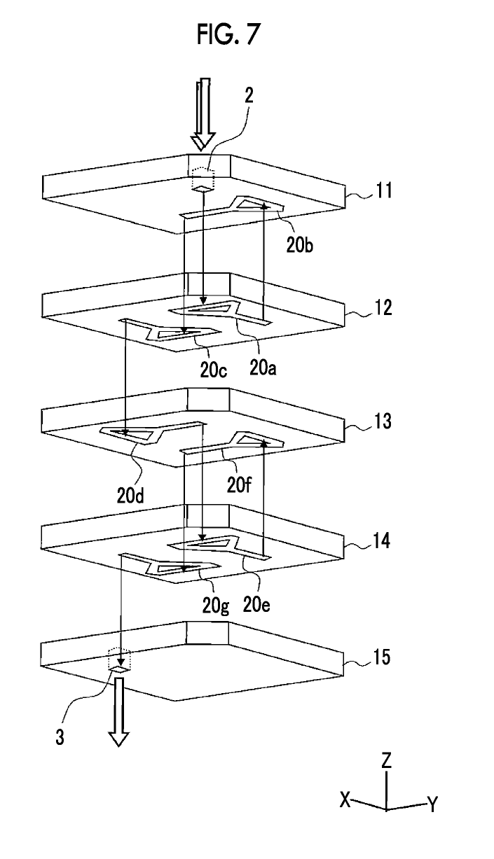

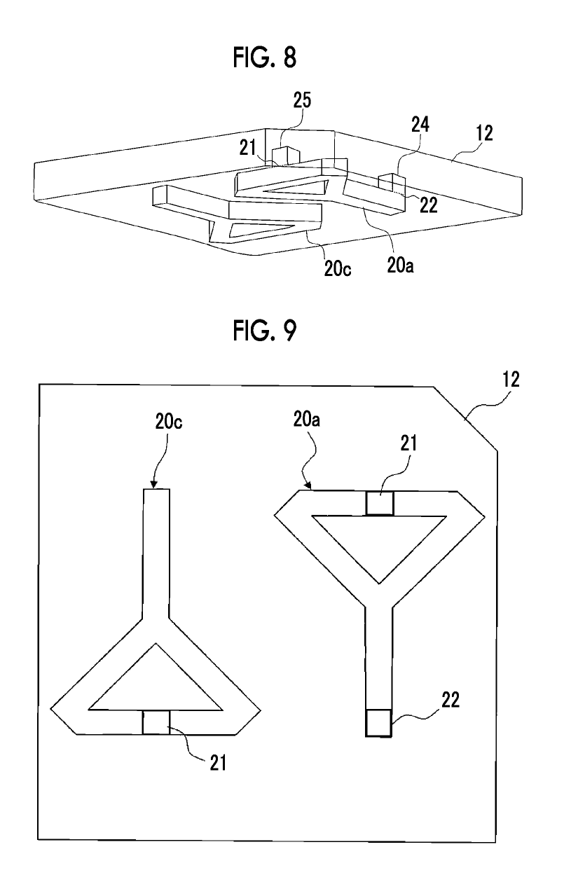

In the fluid mixing device 1 shown in FIG. 1, the three-dimensional flow channel 4 is configured by stacking flow channel plates 11 to 14 in which each of the flow channel units 20a to 20g is formed by a groove. FIG. 7 is an exploded perspective view of the fluid mixing device 1 according to this embodiment. FIG. 8 is a perspective view showing the configuration of the second flow channel plate 12 from the top shown in FIG. 7, and FIG. 9 is a bottom view thereof.

As shown in FIG. 7, the fluid mixing device 1 is configured by stacking the flow channel plates 11 to 14 configuring the first to fourth layers from the top and a base plate 15. The fluid inlet 2 and the flow channel unit 20b are formed in the flow channel plate 11. The flow channel units 20a and 20c are formed in the flow channel plate 12. The flow channel units 20d and 20f are formed in the flow channel plate 13. The flow channel units 20e and 20g are formed in the flow channel plate 14. The fluid outlet 3 is formed in the base plate 15.

Each of the flow channel units 20a to 20g is formed between a groove formed on the lower side of each of the flow channel plates 11 to 14 and a flat surface of an adjacent flow channel plate or the base plate which is in close contact with each flow channel plate so as to cover the groove. In this manner, in a case where the groove of each of the flow channel units 20a to 20g is formed on the lower side of each of the flow channel plates 11 to 14, a connection flow channel connecting the inflow port 21 and the outflow port 22 of each flow channel unit is configured with a through-hole which is formed on the upper side of each of the flow channel plates 11 to 14 to penetrate each flow channel plate.

For example, as shown in FIGS. 8 and 9, in the flow channel plate 12, the grooves for the flow channel units 20a and 20c are formed on the lower side thereof and connection flow channels 24 and 25 which are connected to the inflow port 21 and the outflow port 22 of the flow channel unit 20a are formed on the upper side thereof. In this way, the flow channel units 20a to 20g are connected as shown by the arrows in FIG. 7, whereby the three-dimensional flow channel 4 is configured.

In this manner, in the fluid mixing device 1 according to this embodiment, by forming the respective flow channel units 20a to 20g in the flow channel plates 11 to 14 configuring the respective layers, it is possible to configure the three-dimensional flow channel 4 described above. According to this, it is possible to configure the three-dimensional flow channel 4 according to this embodiment with an extremely simple configuration as compared with a case where the flow channel units 20a to 20g are configured with pipes and connected to each other.

In a case where two flow channel units are formed in a single flow channel plate, like the flow channel plates 12 to 14 shown in FIG. 7, the two flow channel units are formed with the direction of a flow from the inflow port to the outflow port of each flow channel unit being reversed by 180 degrees, whereby the installation area can be reduced. In this manner, the installation area can be reduced as the number of flow channel units which are formed in a single flow channel plate is increased or the density thereof is increased.

Further, the respective flow channel units 20a and 20c of the flow channel plate 12 are disposed in the same direction as the respective flow channel units 20e and 20g of the flow channel plate 14, and therefore, the same flow channel plate can be used for the flow channel plates 12 and 14. Furthermore, the flow channel pattern shown in FIG. 5 can be increased with a simple configuration in which the same flow channel plates as the flow channel plates 13 and 14 are alternately laminated in this order further toward the lower side than the flow channel plate 14. The mixing efficiency increases as the number of flow channel patterns increases. Therefore, it is possible to more easily increase the mixing efficiency.

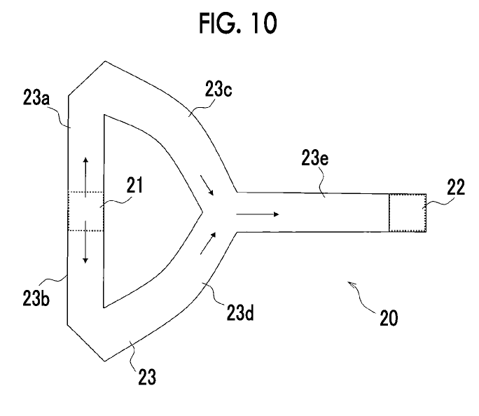

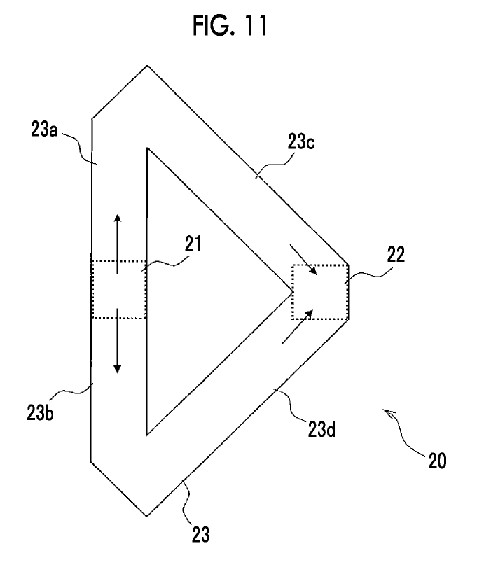

In this embodiment, the basic shape of each of the flow channel units 20a to 20g is not limited to the shape shown in FIG. 4. For example, the branch flow channel 23 may be configured with a curved line, as shown in FIG. 10. FIG. 10 is an example in which each of the second flow channels 23c and 23d is configured with a curved line. However, each of the first flow channels 23a and 23b may be configured with a curved line. Further, in the basic shape of each of the flow channel units 20a to 20g shown in FIG. 4, a case where the joining flow channel 23e is connected to the second flow channels 23c and 23d is given as an example. However, the joining flow channel may be eliminated, as shown in FIG. 11. FIG. 11 shows a case where the outflow port 22 is formed at a joining portion of the second flow channels 23c and 23d. Also in the three-dimensional flow channels configured of the flow channel units 20a to 20g having the basic shapes shown in FIGS. 10 and 11, it is possible to exhibit the same effect as that in the three-dimensional flow channel 4 by the flow channel units 20a to 20g each having the basic shape shown in FIG. 4.

Further, a configuration is also acceptable in which in the flow channel unit 20 shown in FIGS. 3 and 4, the inflow port 21 and the outflow port 22 are interchanged with each other.

As described above, in the fluid mixing device 1 according to this embodiment, by disposing the plurality of flow channel units 20a to 20g in a plurality of layers and disposing the flow channel units 20a to 20g such that the flow directions in the respective flow channel units 20a to 20g intersect each other between the respective layers, it is possible to divide the laminar flow flowing through each of the flow channel units 20a to 20g perpendicularly to the boundary surface therebetween, and it is possible to repeat this. In this way, it is possible to greatly improve the mixing rate of the fluid.

Furthermore, by disposing the plurality of flow channel units 20a to 20g in the respective layers such that the direction of the flow is changed by 90 degrees, it is possible to form a flow that rotates in the fluid mixing device 1. In this way, it is possible to make the installation area of the entire three-dimensional flow channel 4 more compact. Further, it is possible to increase the number of times of division of the laminar flow perpendicularly to the boundary surface only by adding the flow channel pattern of the three-dimensional flow channel 4. In this way, it is possible to further improve the mixing rate of the fluid without changing the installation area.

The three-dimensional flow channel 4 shown in FIG. 2 in this embodiment can also be used upside down. In this case, the flow direction of the fluid shown in FIG. 4 is reversed. Even in this way, the flow directions in the respective flow channel units are disposed so as to intersect each other between the respective layers, and therefore, it is possible to divide the laminar flow flowing in the flow channel unit perpendicularly to the boundary surface, and it is possible to repeat this. In this way, similar to the case of the three-dimensional flow channel 4 shown in FIG. 2, it is possible to greatly improve the mixing rate of the fluid.

Further, in the embodiment described above, a case where the present invention is applied to a fluid mixing device that mixes a sample of human body ingesta or the like with a reagent has been taken and described as an example. However, there is no limitation thereto, and the present invention can be applied to various fluid mixing devices that mix a plurality of fluids. For example, the present invention may be applied to a fluid mixing device that mixes liquid fuel with water.

It should be understood by those skilled in the art that various modifications, combinations, sub-combinations and alterations may occur depending on design requirements and other factors insofar as they are within the scope of the appended claims of the equivalents thereof.

1. A fluid mixing device that mixes a plurality of fluids, comprising:
a plurality of flow channel units disposed to be divided in a plurality of layers,
wherein each of the plurality of flow channel units has one respective inflow port, one respective outflow port, and a plurality of branch flow channels making the respective inflow port and the respective outflow port communicate with each other,
the respective inflow port of the respective flow channel unit on one side, out of the flow channel units which are located in different layers, and the respective outflow port of the respective flow channel unit on the other side are connected to each other, whereby a three-dimensional flow channel is configured such that a length of a flow channel through which the fluid flows is the same or substantially the same in any of the branch flow channels, and
when a direction from the respective inflow port to the respective outflow port is set to be a flow direction of the fluid in each of the respective flow channel units, the flow directions intersect each other between the respective layers.

2. The fluid mixing device according to claim 1, wherein the flow directions in the connected flow channel units are orthogonal to each other.

3. The fluid mixing device according to claim 1, wherein the branch flow channels of each of the respective flow channel units are configured with two first flow channels which divide the fluid flowing in from the inflow port into two fluid flows and lead the split fluids in directions in which the split fluids become more distant from each other, and two second flow channels which turn the split fluids from the respective first flow channels so as to lead the split fluids in directions in which the split fluids approach each other, and make the split fluids join together.

4. The fluid mixing device according to claim 2, wherein the branch flow channels of each of the respective flow channel units are configured with two first flow channels which divide the fluid flowing in from the inflow port into two fluid flows and lead the split fluids in directions in which the split fluids become more distant from each other, and two second flow channels which turn the split fluids from the respective first flow channels so as to lead the split fluids in directions in which the split fluids approach each other, and make the split fluids join together.

5. The fluid mixing device according to claim 3, wherein an angle between the two first flow channels is an angle greater than 90 degrees and less than or equal to 180 degrees, and an angle between the two second flow channels is an angle smaller than 180 degrees.

6. The fluid mixing device according to claim 4, wherein an angle between the two first flow channels is an angle greater than 90 degrees and less than or equal to 180 degrees, and an angle between the two second flow channels is an angle smaller than 180 degrees.

7. The fluid mixing device according to claim 3, wherein the first flow channels and the second flow channels are straight lines or curved lines.

8. The fluid mixing device according to claim 4, wherein the first flow channels and the second flow channels are straight lines or curved lines.

9. The fluid mixing device according to claim 5, wherein the first flow channels and the second flow channels are straight lines or curved lines.

10. The fluid mixing device according to claim 6, wherein the first flow channels and the second flow channels are straight lines or curved lines.

11. The fluid mixing device according to claim 1, wherein a plurality of the flow channel units are disposed in at least one of the layers.

12. The fluid mixing device according to claim 1, wherein at least two of the layers having the plurality of flow channel units are stacked.

13. The fluid mixing device according to claim 11, wherein at least two of the layers having the plurality of flow channel units are stacked.

14. The fluid mixing device according to claim 1, wherein a plurality of flow channel plates are laminated to be stacked in a thickness direction thereof, the flow channel unit is formed between a groove formed in a surface of the flow channel plate on one side and a flat surface of the flow channel plate on the other side which is stacked on the flow channel plate on one side, and three or more of the flow channel plates are stacked, whereby the plurality of layers are formed.

15. The fluid mixing device according to claim 11, wherein a plurality of flow channel plates are laminated to be stacked in a thickness direction thereof, the flow channel unit is formed between a groove formed in a surface of the flow channel plate on one side and a flat surface of the flow channel plate on the other side which is stacked on the flow channel plate on one side, and three or more of the flow channel plates are stacked, whereby the plurality of layers are formed.

16. The fluid mixing device according to claim 12, wherein a plurality of flow channel plates are laminated to be stacked in a thickness direction thereof, the respective flow channel unit is formed between a groove formed in a surface of the flow channel plate on one side and a flat surface of the flow channel plate on the other side which is stacked on the flow channel plate on one side, and three or more of the flow channel plates are stacked, whereby the plurality of layers are formed.

17. The fluid mixing device according to claim 13, wherein a plurality of flow channel plates are laminated to be stacked in a thickness direction thereof, the flow channel unit is formed between a groove formed in a surface of the flow channel plate on one side and a flat surface of the flow channel plate on the other side which is stacked on the flow channel plate on one side, and three or more of the flow channel plates are stacked, whereby the plurality of layers are formed.
